(19) United States
(12) Patent Application Publication
(10) Pub. No.: US 2018/0245634 A1
(43) Pub. Date: Aug. 30, 2018

(54) BALL LOCK CONNECTOR

(71) Applicant: Centrix Aero, LLC, Kent, WA (US)

(72) Inventor: Andres Hernandez, Yorba Linda, CA (US)

(21) Appl. No.: 15/904,250

(22) Filed: Feb. 23, 2018

Related U.S. Application Data
(60) Provisional application No. 62/463,586, filed on Feb. 24, 2017.

(51) Int. Cl. F16C 29/06; F16C 9/04; F16C 29/10

(52) U.S. Cl. CPC F16C 29/0685; B64D 11/003; F16C 29/10; F16C 9/04

(57) ABSTRACT

A connection rod assembly is provided that includes a connection rod, a first ball lock connector including an outer pin slidably mated with an inner spindle, including an aperture, and coupled to the connection rod, a ball lock bearing at least partially positioned within the aperture, an actuation interface coupled to the inner spindle, slidable with regard to the outer pin, and including a sleeve at least partially surrounding the outer pin, and a spring positioned within the outer pin. In a locked configuration the spring is unloaded and the ball lock bearing radially extends beyond an outer surface of the outer pin and engages with a detent in a first component. On the other hand, in an unlocked configuration the spring is loaded and the ball lock bearing is retained in a groove in the inner spindle.

### CROSS REFERENCE TO RELATED APPLICATION

The present application claims priority to U.S. Provisional Application No. 62/463,586, entitled “BALL LOCK CONNECTOR,” filed Feb. 24, 2017. The entire contents of the above-referenced application are hereby incorporated by reference in its entirety for all purposes.

### TECHNICAL FIELD

This description relates generally to a connection rod assembly with a ball lock connector, such as for a storage bin in an aircraft.

### BACKGROUND

Previous connection rod systems require separate components to be assembled via tooling. For example, connection rods may include threaded holes that interface with threaded screws or cotter pins that extend through holes in the rod. Therefore, during assembly installation personnel not only have to carry the loose parts but also the corresponding tools. As such, the chance of dropping, misplacing, improperly installing, etc., the loose parts is increased due to the complexity of the installation procedure. Moreover, the complex installation process may decrease installation efficiency, thereby increasing manufacturing costs. In confined installation spaces, such as in aircraft applications, the aforementioned problems are exacerbated. Moreover, in aircraft applications the loss of components is particularly problematic and may cause unwanted damage to surrounding components during flight. This type of damage is referred to in the art as foreign object debris (FOD) which causes significant amounts of damage to airplane components and systems each year. Accordingly, the inventor has recognized a need to reduce the likelihood of losing components during installation and to increase installation efficiency of connection rod assemblies.

### SUMMARY

The inventor has recognized the aforementioned problems and have developed a connection rod assembly to at least partially address the problems. The connection rod assembly may include a connection rod, a first ball lock connector including, an outer pin slidably mated with an inner spindle, including an aperture, and coupled to the connection rod, a ball lock bearing at least partially positioned within the aperture, an actuation interface coupled to the inner spindle, slidable with regard to the outer pin, and including a sleeve at least partially surrounding the outer pin, and a spring positioned within the outer pin, where in a locked configuration the spring is unloaded and the ball lock bearing radially extends beyond an outer surface of the outer pin and engages with a detent in a first component, and where in an unlocked configuration the spring is loaded and the ball lock bearing is retained in a groove in the inner spindle.

The actuation interface and the ball locking bearing features of the connection rod assembly enables the assembly to be installed by hand with limited use of tools and in some cases without tools, if desired. Specifically, in one example, a worker may grip the actuation interface and apply axial force thereto to place the ball lock connector in an unlocked configuration, mate the ball lock connector with the component, and then release the axial force to place the ball lock connector in a locked configuration where the ball lock connector is securely attached to the component. Consequently, installation efficiency of the assembly is increased and the likelihood of component misplacement during installation is reduced (e.g., substantially eliminated), thereby decreasing manufacturing and servicing costs of the connection rod assembly. Moreover, providing a connection rod assembly with the features described above enables the likelihood of unwanted component damage caused by lost components to be diminished.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

Many of the attendant features will be more readily appreciated as the same becomes better understood by reference to the following detailed description considered in connection with the accompanying drawings.

### DESCRIPTION OF THE DRAWINGS

FIG. 1 is a perspective view of an example of a connection rod assembly.

FIG. 2 is a side view of the connection rod assembly, shown in FIG. 1.

FIG. 3 is a cross-sectional view of the connection rod assembly, shown in FIG. 2.

FIG. 4 is a detail view of a first ball lock connector in the connection rod assembly, shown in FIG. 3.

FIG. 5 shows a more detailed view of the first ball lock connector, shown in FIG. 4, in a locked configuration.

FIG. 6 shows the portion of the first ball lock connector, shown in FIG. 5, an unlocked configuration.

FIG. 7 shows a use case installation environment for a connection rod assembly.

FIG. 8 shows an assembly method for a connection rod assembly.

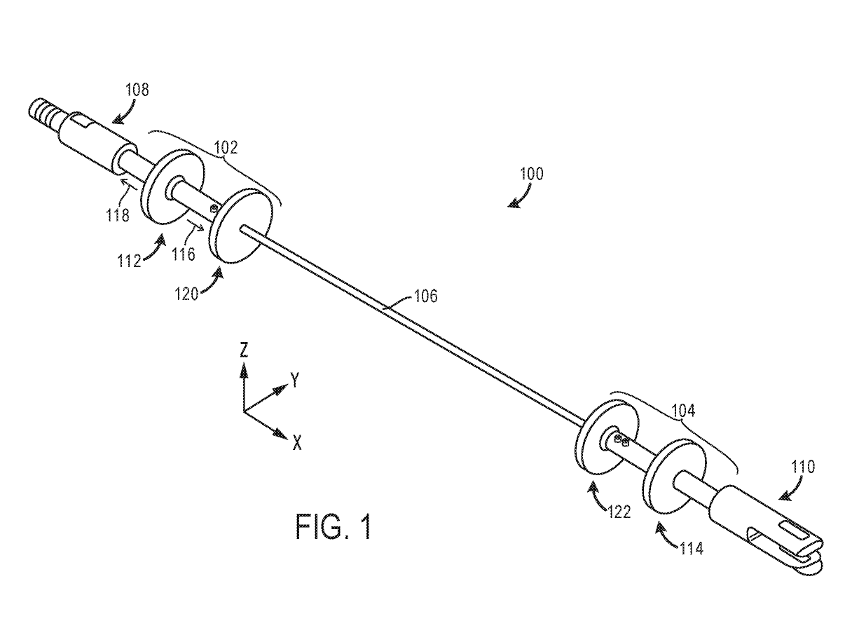

FIGS. 1-7 are drawn to scale. However, other relative dimensions may be used in other embodiments.

### DETAILED DESCRIPTION

A connection rod assembly is described herein that increases installation efficiency of the assembly while reducing (e.g., substantially eliminating) the chance of losing or misplacing components in the assembly during installation. In one example, the connection rod assembly includes a ball lock connector with an outer pin that is coupled to a component. The ball lock connector also includes an actuation interface coupled to an inner spindle and slidable with regard to an outer pin. The actuation interface allows the ball lock connector to be quickly and efficiently set in a locked and unlocked configuration. In the locked configuration a spring in the ball lock connector is unloaded and a ball lock bearing is urged by the inner spindle such that it radially extends beyond an outer surface of the outer pin and engages with a detent in a component. On the other hand, in an unlocked configuration the spring is loaded and the ball lock bearing is retained in a groove in the inner spindle. In this way, installation personnel may efficiently actuate the ball lock connector to provide quick attachment/detachment with/from the component. When this type of connection rod assembly is used in an aircraft the time needed to install the assembly is reduced and the likelihood of component loss is also reduced, thereby reducing aircraft manufacturing costs. Although the present examples are described and illustrated herein as being implemented in an aircraft system, the system described is provided as an example and not a limitation. As those skilled in the art will appreciate, the present examples are suitable for application in a variety of different types of removable fastener systems including but not limited to industrial fastener systems, automotive fastener systems, home furnishing fastener systems, etc.

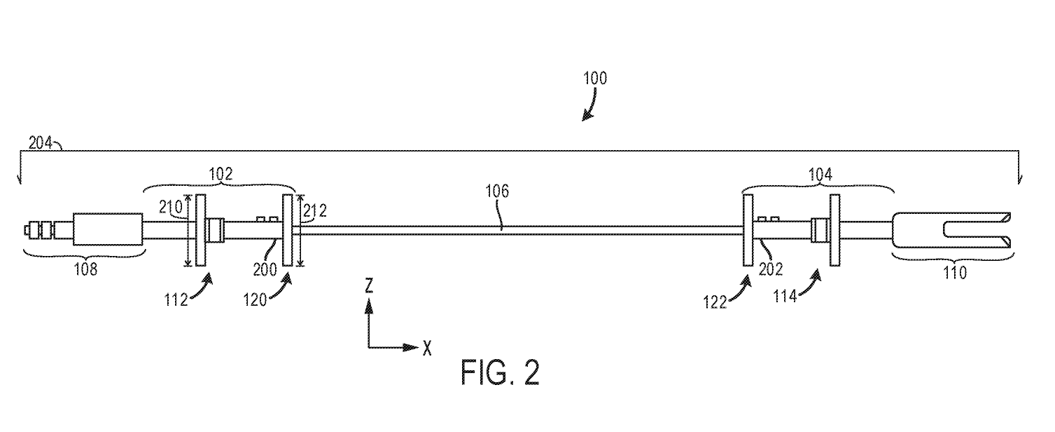

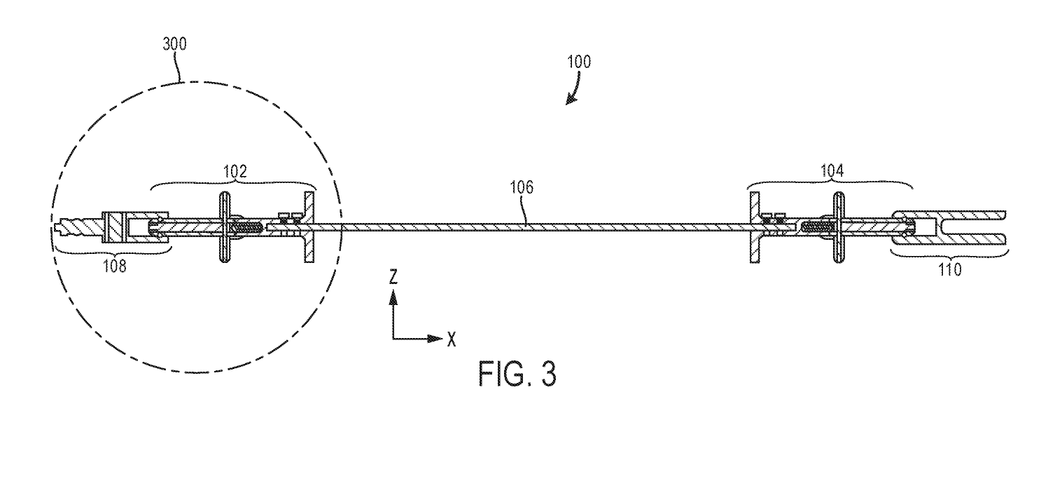

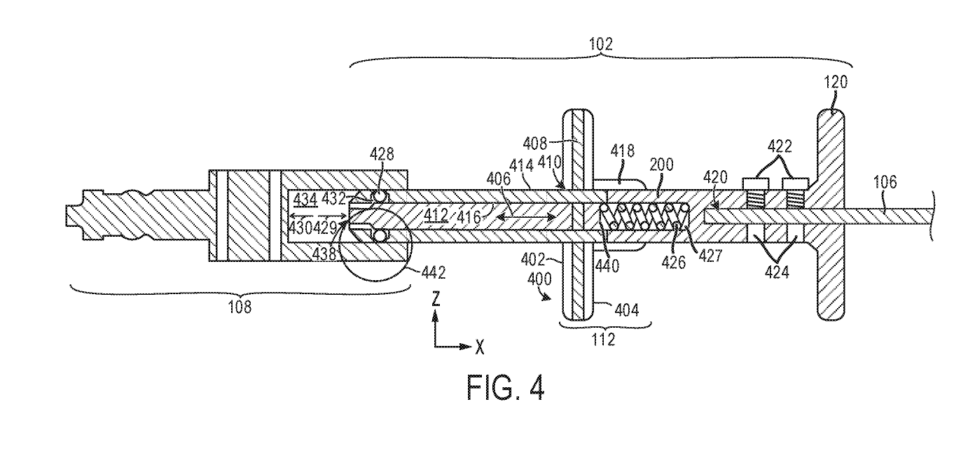

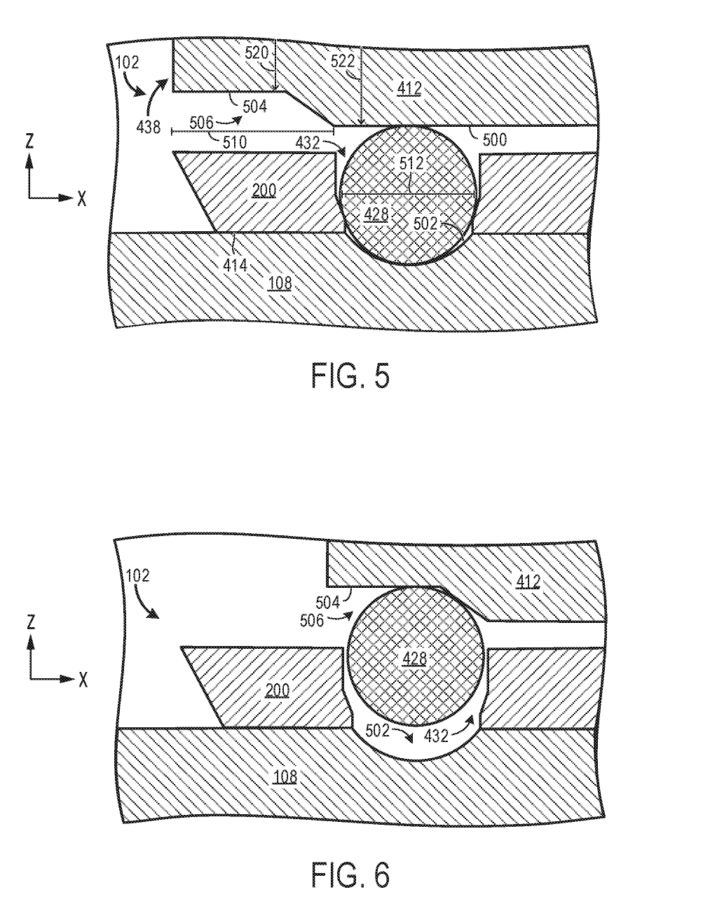

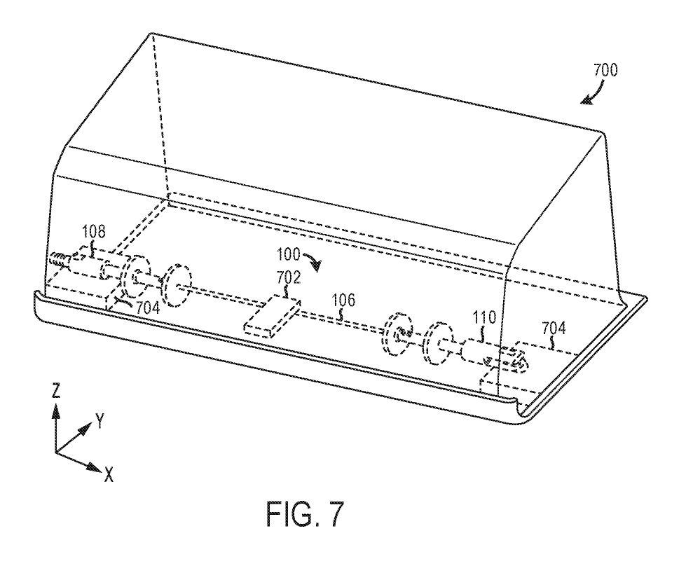

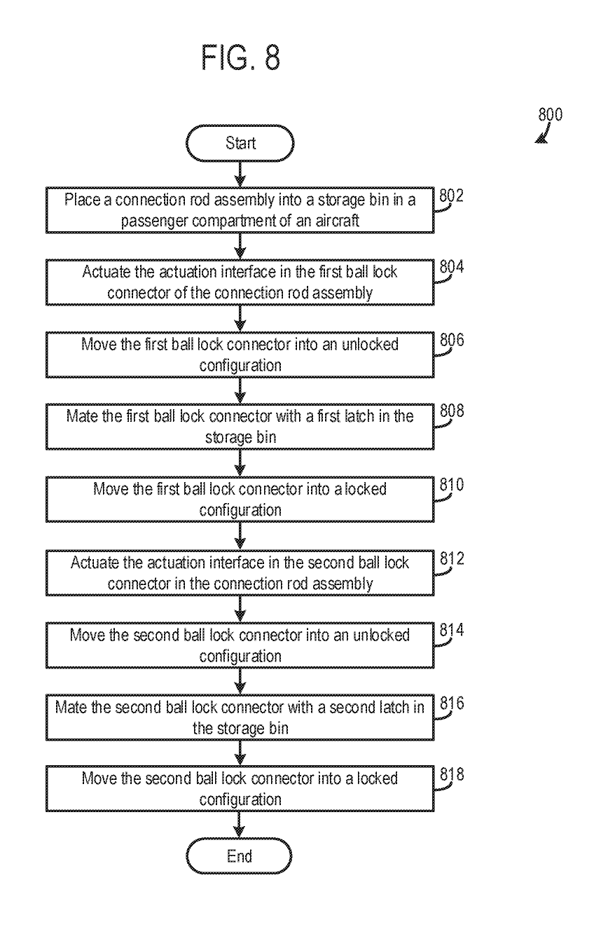

FIG. 1 is a perspective view of an example connection rod assembly with ball lock connectors. FIG. 2 shows a side view of the ball lock connectors in the connection rod assembly engaged with associated components. FIG. 3 shows a cross-sectional view of the connection rod assembly, shown in FIG. 2. FIG. 4 shows a detailed view of a portion of the connection rod assembly, shown in FIG. 3. FIG. 5 shows a detailed view of another portion of the connection rod assembly, shown in FIG. 4, in a locked configuration. FIG. 6 shows the portion of the connection rod assembly, illustrated in FIG. 4, in an unlocked configuration. FIG. 7 shows an installation environment for the connection rod assembly, shown in FIGS. 1-6. FIG. 8 shows an assembly method for a connection rod assembly. References axes X, Y, and Z are provided in FIGS. 1-7 for reference.

Turning to FIG. 1, showing a connection rod assembly 100. The connection rod assembly 100 includes a first ball lock connector 102, a second ball lock connector 104, and a connection rod 106 extending there between. The first ball lock connector 102 is coupled (e.g., releasably coupled) to a first component 108. Likewise, the second ball lock connector 104 is coupled (e.g., releasably coupled) to a second component 110.

The first component 108 may be included in a first latch in an aircraft storage bin and the second component 110 may be included in a second latch in an aircraft storage bin. Thus, the connection rod 106 may transfer motion from the first component to the second component, in one example.

The connection rod 106 extends between the first ball lock connector 102 and the second ball lock connector 104 and is coupled (e.g., removably coupled) to each of the ball lock connectors. The connection rod 106 has a constant diameter along the axial length of the rod. However, in other instances the diameter of the rod may vary along the axial length of the rod.

In the illustrated example, the first ball lock connector 102 is similar in size and has similar functionality to the second ball lock connector 104. However, variations (e.g., structural and/or function variations) between the ball lock connectors have been contemplated. For instance, the first ball lock connector 102 may be larger (e.g., have a larger diameter, greater length, etc.) than the second ball lock connector 104 or vice versa to accommodate attachment to differently sized components.

The first ball lock connector 102 includes an actuation interface 112 and the second ball lock connector 104 also includes another actuation interface 114. The actuation interface 112 may be moved in opposing directions (e.g., axial directions) to place the first ball lock connector 102 in locked and unlocked configurations to enable the ball lock connector to be attached to and released from the first component 108. Specifically, in the illustrated example, movement of the actuation interface 112 in a first axial direction 116 inward towards the second ball lock connector 104 places the first ball lock connector 102 in an unlocked configuration. On the other hand, movement of the actuation interface 112 in a second axial direction 118 outward away from the second ball lock connector 104 places the first ball lock connector 102 in a locked configuration. It will be appreciated that similar actuation of the actuation interface 114 in the second ball lock connector 104 may place the connector in locked and unlocked configurations. It will also be appreciated that both the first ball lock connector 102 and the second ball lock connector 104 are in a locked configuration in FIG. 1.

A flange 120 is included in the first ball lock connector 102 and a flange 122 is included in the second ball lock connector 104, in the illustrated example. The flanges 120 and 122 may enable installation personnel to easily actuate the ball lock connectors by providing anchor points for their hands to actuate the actuation interfaces 112 and 114. Consequently, personnel may quickly and efficiently actuate the actuation interfaces with limited use of tools or without tools in some cases, if desired. However, in other examples, tools may be used to install the connection rod assembly. The flanges 120 and 122 have a disk shape (e.g., annular shape) in the illustration. However, other flange contours have been contemplated such as flanges with one or more tabs that radially extend away from the connectors, arced flanges, flanges that curve in axially inward or outward directions, etc. In other examples, the flanges may not be included in the first and/or second ball lock connectors.

FIG. 2 shows a side view of the connection rod assembly 100. Again, the first ball lock connector 102, the second ball lock connector 104, the connection rod 106, the first component 108, and the second component 110 are shown.

The actuation interfaces 112 and 114 and flanges 120 and 122 are also shown in FIG. 2. The flange 120 is coupled (e.g., fixedly coupled) to an outer pin 200 in the first ball lock connector 102. Likewise, the flange 122 is coupled (e.g., fixedly coupled) to an outer pin 202 in the second ball lock connector 104.

The actuation interface 112 is slideably mated with the outer pin 200 to enable unlocking/locking action in the first ball lock connector 102. Likewise, the actuation interface 114 is slideably mated with the outer pin 202 to enable unlocking/locking action in the second ball lock connector 104. Viewing plane 204 indicates the location of the cross-sectional view shown in FIG. 3.

FIG. 2 also shows an outer diameter 210 of the actuation interface 112 and an outer diameter 212 of the flange 120. In the illustrated example, the outer diameter 210 is equivalent to the outer diameter 212. When the actuation interface 112 and the flange 120 have similar diameters, the assembly may be more efficiently installed and actuation of the interface may be efficiently carried out. However, embodiments have been contemplated where the diameter of the flange 120 and the diameter of the actuation interface 112 are not equal. For example, the flange may have a larger diameter than the diameter of the actuation interface or vice versa.

FIG. 3 again shows the connection rod assembly 100 with the first ball lock connector 102, connection rod 106, second ball lock connector 104, first component 108, and second component 110. It will be appreciated that FIG. 3 shows the first ball lock connector 102 mated with and releasably attached to the first component 108 and also shows the second ball lock connector 104 mated with and releasably attached to the second component 110. The internal components in the first ball lock connector 102 and the second ball lock connector 104 are similar. However, as previously discussed variations in internal componentry has been contemplated. The boundary of the detailed view shown in FIG. 4 is indicated at 300.

FIG. 4 shows a detailed view of the first ball lock connector 102 coupled to the connection rod 106 and the first component 108. The actuation interface 112 is illustrated as having a disk shaped section 400 with a first outer surface 402 and a second outer surface 404 that are both radially aligned. However, other actuation interface geometries have been contemplated. For instance, the actuation interface may include one or more tabs, protrusions, etc., that extend at least partially in a radial direction from a central axis 406 of the first ball lock connector 102. The faces of the tabs, protrusions, etc., may or may not be radially aligned, in some examples.

Additionally, a connecting pin 408 of the actuation interface 112 extends through slots 410 in the outer pin 200 and is connected (e.g., fixedly connected) to an inner spindle 412 such that axial movement of the actuation interface 112 causes axial movement of the inner spindle 412. Specifically, the slots 410 extend from an outer surface 414 of the outer pin 200 to an interior surface 416 of the outer pin. The slots 410 also axially traverse a wall of the outer pin 200 to accommodate axial movement of the actuation interface 112 with regard to the outer pin 200.

The actuation interface 112 also include a sleeve 418 mating with the outer pin 200. The sleeve 418 guides the actuation interface 112 through axial movement between the actuation interface and the outer pin 200. Thus, the sleeve 418 circumferentially surrounds the outer surface 414 of the outer pin 200. In this way, the actuation interface 112 is slidingly engaged with the outer pin 200.

The flange 120 is shown extending from the outer pin 200 and may be fixedly coupled to the outer pin 200. Consequently, the flange 120 may serve as an anchor point for a user's hand during actuation of the actuation interface 112, if desired.

The connection rod 106 is also shown mated with an opening 420 in the outer pin 200. The connection rod 106 axially extends into an axial section between the actuation interface 112 and the flange 120. Set screws 422 extend (e.g., radial extend) through screw openings 424 (e.g., radially aligned screw openings) in the outer pin 200. The set screws 422 enable the connection rod 106 to be releasably attached to the outer pin 200.

The set screws may be helically mated with the screw openings 424 and/or recesses (not shown) in the connection rod 106 to enable secure attachment between the connection rod and the outer pin. Additionally or alternatively, the connection rod 106 may be coupled to the outer pin 200 via adhesive, press fitting, clamping, combinations thereof, etc.

The first ball lock connector 102 also include a spring 426 position in an interior cavity 427 of the outer pin 200. The spring 426 is illustrated as a coil spring in FIG. 4. However, other types of springs may be used in the connector, in other examples, such as leaf springs, elastomer springs, combinations thereof, etc. The spring 426 is positioned axially between the disk shaped section 400 of the actuation interface 112 and the flange 120. When the spring 426 is positioned in this manner the actuation interface can efficiently actuate the spring.

The spring 426 may be loaded and unloaded via axial movement of the inner spindle 412. Loading and unloading of the spring 426 causes the first ball lock connector 102 to be placed in a locked configuration and an unlocked configuration, discussed in greater detail herein. It will be appreciated that axial actuation of the actuation interface 112 causes axial motion of the inner spindle 412. In particular, movement of the inner spindle 412 in an axial direction 429 away from ball lock bearings 428 compresses and loads the spring 426. Conversely, movement of the inner spindle 412 in an axial direction 430 toward the ball lock bearings 428 decompresses and unloads the spring 426.

In the illustrated example, the first ball lock connector 102 includes a plurality of ball lock bearings and specifically includes two ball lock bearings positioned on radially opposing sides of the connector. However, ball lock connectors with a single ball lock bearing or more than two ball lock bearings with or without different ball spacing have been contemplated. For instance, the first ball lock connector 102 may include four ball lock bearings which may be spaced 90° apart with regard to sequential bearings. In other examples, the first ball lock connector 102 may include a single ball lock bearing or three ball lock bearings which may be spaced 120° apart. Providing additional bearings in the connector may increase the strength of attachment between the connector and the component.

The ball lock bearings 428 are retained in apertures 432 in the outer pin 200 in both the locked and unlocked configurations of the first ball lock connector 102. The apertures 432 may taper in a radially outward direction to retain the bearings. Thus, in each aperture an inner width of the aperture may be greater than an outer width of the aperture. Moreover, the outer width of the aperture may be less than a diameter of the bearing.

The ball lock bearings 428 may move radially inwards when transitioning to a locked configuration and radially outwards when transitioning to an unlocked configuration. When moved outward into a locked configuration the ball lock bearings 428 engages with the first component 108. An opening 434 in the first component 108 receiving a portion of the first ball lock connector 102 is also shown in FIG. 4. A first end 438 of the inner spindle 412 is shown positioned in the opening 434. A second end 440 of the inner spindle 412 is also shown abutting the spring 426. The boundary of the detailed view shown in FIG. 4 is indicated at 442.

FIG. 5 shows a detailed view of a portion of the first ball lock connector 102, shown in FIG. 4. In particular, the inner spindle 412, the outer pin 200, and the ball lock bearing 428 in the first ball lock connector 102 are shown.

The first ball lock connector 102 shown in FIG. 5 is in a locked configuration where the connector is releasably coupled to the first component 108. In the locked configuration the ball lock bearings 428 are pushed radial outward via a locking surface 500 in the inner spindle 412. When the ball lock bearings 428 are pushed radially outward and the ball lock connector is mated with the first component 108 such that the bearings engage with detents 502 in the component 108 while being retained in the apertures 432. Thus, in the locked configuration the ball lock bearing 428 radially extends beyond the outer surface 414 of the outer pin 200 and extends into the detent 502 of the first component 108. In this way, the first ball lock connector 102 is attached to the first component 108.

The locking surface 500 in the inner spindle 412 therefore urges the ball lock bearing 428 radially outward in the locked configuration. FIG. 5 also shows an unlocking surface 504 in the inner spindle 412. The unlocking surface 504 may forms a boundary of a groove 506 in which the ball lock bearing 428 may reside when the connector is in an unlocked configuration. The groove 506 is shown positioned at the end 438 in the inner spindle 412. In this way, the compactness of the ball lock connector may be increased. However, other groove positions have been contemplated.

The unlocking surface 504 has a smaller radius 520 than a radius 522 of the locking surface 500 with regard to the central axis 406 first ball lock connector 102, shown in FIG. 4. In this way, the unlocking surface 504 may retain the ball lock bearings 428 while the first ball lock connector 102 is in an unlocked configuration. Moreover, a width 510 of the groove 506 may be equal to or greater than a diameter 512 of the ball lock bearing 428. However, in other examples, the width of the groove may be less than the diameter of the ball lock bearing.

FIG. 6 shows the portion of the ball lock connector 102 illustrated in FIG. 5 in the unlocked configuration. The inner spindle 412, the outer pin 200, and the ball lock bearing 428 in the first ball lock connector 102 are again shown.

As shown, the ball lock bearing 428 is retracted into the aperture 432 in the outer pin 200 such that the bearing is spaced away from the detent 502 in the first component 108. In the unlocked configuration the ball lock bearing 428 is still retained in the aperture 432 but moved further radially inwards such that it is adjacent to (e.g., in face sharing contact with) the unlocking surface 504. Thus, the ball lock bearing may be held in the groove 506 in the inner spindle 412 when unlocked.

FIG. 7 shows a use case example where the connection rod assembly 100 is included in an aircraft storage bin 700 of an aircraft. The storage bin may be positioned in a passenger compartment of the aircraft and accessable to passengers. However, as previously discussed, a variety of operating environments for the connection rod assembly have been contemplated. In FIG. 7 the dashed lines indicate the internal componentry in the aircraft storage bin 700 providing a see-through type view. An actuation interface 702 (e.g., latch handle) is shown coupled to the connection rod 106 in the connection rod assembly 100. Actuation of the actuation interface 702 by an airplane passenger, for example, may cause motion (e.g., rotational and/or axial motion) to be translated through the connection rod assembly 100 to the mechanisms 704 (e.g., latches) in the aircraft storage bin 700. The mechanisms 704 may include or be coupled to the first component 108 and the second component 108. For example, the first component 108 may be mated with or otherwise mechanically attached to one of the mechanisms 704. Likewise, the second component 110 may be mated with or otherwise mechanically attached to one of the mechanisms 704.

The motion transferred from the actuation interface 702 to the mechanisms 704 may cause the configuration of the mechanisms to change. For example, when the mechanisms 704 are latches actuation of the actuation interface may open the latches and allow the aircraft storage bin to be opened. Continuing with such an example, release of the actuation input may cause the latches to close. Additionally, in the illustrated example, the mechanisms 704 are positioned on either side of the aircraft storage bin 700. However, other locations of the mechanisms may be used. To install the connection rod assembly 100 in the aircraft storage bin 700 the assembly may be placed in the interior of the storage bin and attached to the actuation interface 702. The actuation interfaces in the connection rod assembly may then be actuated to quickly and efficiently connect the assembly to the first and second components 108 and 110 and the mechanisms 704, correspondingly. In this way, the connection rod assembly 100 can be rapidly assembled in the storage bin 700. However, other installation procedures may be used in other examples.

FIGS. 1-7 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

FIG. 8 shows a method 800 for assembling a connection rod assembly. The method 800 may be used to assemble the connection rod assembly discussed above with regard to FIGS. 1-7 or may be used to assemble other suitable connection rod assemblies, in other examples. Moreover, in one example, the method may be at least partially carried out by installation personnel with the use of their hands and with limited or no use of tools, if desired. In this way, the installation efficiency of the assembly is increased while reducing the likelihood of losing assembly components during installation.

At 802 the method includes placing a connection rod assembly into a storage bin in a passenger compartment of an aircraft. Next at 804 the method includes actuating the actuation interface in the first ball lock connector of the connection rod assembly and at 806 the method includes moving the first ball lock connector into an unlocked configuration. Thus, it will be appreciated that the ball locked connector may be moved into an unlocked configuration when the actuation interface is actuated. For instance, installation personnel may grip the actuation interface and move it axially away from the end of the first ball lock connector having ball lock bearings positioned therein. Movement of the actuation interface in this manner loads the spring in the connector and allows the ball lock bearings to move inwardly and be retained in a groove in the inner spindle. In the unlocked configuration the ball lock bearing may be positioned radial inward from an outer surface of the outer pin. It will be appreciated that actuation of the actuation interface may be sustained to keep the ball lock connector in the unlocked configuration. As such, actuation of the actuation interface may be sustained through step 808.

Next at 808 the method includes mating the first ball lock connector with a first latch in the storage bin. For example, an end of the first ball lock connector with the ball lock bearings may be inserted into an opening in the first latch of the storage bin.

Next at 810 the method includes moving the first ball lock connector into a locked configuration. In this way, the first ball lock connector may be securely attached to the storage bin latch with a quick and efficient process, thereby increasing installation efficiency. Next at 812 the method includes the method includes actuating the actuation interface in the second ball lock connector in the connection rod assembly.

At 814 the method includes moving the second ball lock connector into an unlocked configuration and at 816 the method includes mating the second ball lock connector with a second latch in the storage bin.

At 818 the method includes moving the second ball lock connector into a locked configuration. Method 800 enables the ball lock connectors in the connection rod assembly to be quickly attached to latches in the aircraft storage bin. It will be appreciated that in some examples, steps 804-810 and 812-818 may occur at overlapping time periods (e.g., a simultaneous time period). However, in other examples, steps 804-818 may occur at sequential time intervals.

Furthermore, in some examples, the connection rod may be attached to the first ball lock connector and/or the second ball lock connector prior to step 802. Additionally, in one example, the attachment between the connection rod and the ball lock connectors may occur prior to end-use installation, such as installation in the aircraft storage bin.

The invention will further be described in the following paragraphs. In one aspect, a connection rod assembly is provided. The connection rod assembly includes a connection rod, a first ball lock connector including, an outer pin slidably mated with an inner spindle, including an aperture, and coupled to the connection rod, a ball lock bearing at least partially positioned within the aperture, an actuation interface coupled to the inner spindle, slidable with regard to the outer pin, and including a sleeve at least partially surrounding the outer pin, and a spring positioned within the outer pin, where in a locked configuration the spring is unloaded and the ball lock bearing radially extends beyond an outer surface of the outer pin and engages with a detent in a first component, and where in an unlocked configuration the spring is loaded and the ball lock bearing is retained in a groove in the inner spindle.

In another aspect, a connection rod assembly in an aircraft storage bin is provided. The connection rod assembly includes a connection rod, a first ball lock connector including, an outer pin slidably mated with an inner spindle, including an aperture, and coupled to the connection rod, a ball lock bearing at least partially positioned within the aperture, an actuation interface coupled to the inner spindle and slidable with regard to the outer pin, and a spring positioned within the outer pin, where in a locked configuration the spring is unloaded and the ball lock bearing radially extends beyond an outer surface of the outer pin and engages with a detent in a first latch component, and where in an unlocked configuration the spring is loaded and the ball lock bearing is retained in a groove in the inner spindle.

In another aspect, a method for assembly of a storage bin in a passenger compartment of an aircraft comprising placing a connection rod assembly into the storage bin, the connection rod assembly including, a connection rod, a first ball lock connector including, an outer pin slidably mated with an inner spindle, including an aperture, and coupled to the connection rod, a ball lock bearing at least partially positioned within the aperture, an actuation interface coupled to the inner spindle and slidable with regard to the outer pin, and a spring positioned within the outer pin, and actuating the actuation interface in the first ball lock connector, moving the first ball lock connector into an unlocked configuration where the spring is loaded and the ball lock bearing is retained in a groove in the inner spindle, mating the first ball lock connector with a first latch in the storage bin, and moving the first ball lock connector into a locked configuration where the spring is unloaded and the ball lock bearing radially extends beyond an outer surface of the outer pin and engages with a detent in the first latch. In one example, the method may further include actuating the actuation interface in the second ball lock connector, moving the second ball lock connector into an unlocked configuration where the spring in the second ball lock connector is loaded and the ball lock bearing of the second ball lock connector is retained in a groove in the inner spindle of the second ball lock connector, mating the second ball lock connector with a second latch in the storage bin, and moving the second ball lock connector into a locked configuration where the spring is unloaded and the ball lock bearing in the second ball lock connector radially extends beyond an outer surface of the outer pin in the second ball lock connector and engages with a detent in the second latch.

In any of the aspects or combinations of the aspects, where the connection rod assembly further comprises a second ball lock connector including, an outer pin slidably mated with an inner spindle, including an aperture, and coupled to the connection rod, a ball lock bearing at least partially positioned within the aperture, an actuation interface coupled to the inner spindle and slidable with regard to the outer pin, and a spring positioned within the outer pin.

In any of the aspects or combinations of the aspects, where actuation of the actuation interface in the first ball lock connector includes moving the actuation interface in an axial direction away from the ball lock bearing.

In any of the aspects or combinations of the aspects, where the first ball lock connector further includes a flange extending from the outer pin and where the spring is positioned axially between the flange and a disk shaped section of the actuation interface.

In any of the aspects or combinations of the aspects, the first component may be included in an aircraft storage bin.

In any of the aspects or combinations of the aspects, the connection rod assembly may further include a flange extending from the outer pin.

In any of the aspects or combinations of the aspects, the spring may be positioned axially between the flange and a disk shaped section of the actuation interface.

In any of the aspects or combinations of the aspects, an outer diameter of the flange may be equivalent to an outer diameter of the actuation interface.

In any of the aspects or combinations of the aspects, the outer pin may be fixedly connected to the connection rod via a set screw extending through an opening in the outer pin and mating with a recess in the connection rod.

In any of the aspects or combinations of the aspects, the connection rod may transfer motion from a first component to a second component.

In any of the aspects or combinations of the aspects, the connection rod assembly may further include a second ball lock connector assembly including, an outer pin slidably mated with an inner spindle and including an aperture, a connection rod coupled to the outer pin, a ball lock bearing at least partially positioned within the aperture, an actuation interface coupled to the inner spindle, slidable with regard to the outer pin, and including a sleeve at least partially surrounding the outer pin, and a spring positioned within the outer pin, where in a locked configuration the spring is unloaded and the ball lock bearing radially extends beyond an outer surface of the outer pin and engages with a detent in a second component, and where in an unlocked configuration the spring is loaded and the ball lock bearing is retained in a groove in the inner spindle.

In any of the aspects or combinations of the aspects, the first component may be a first overhead bin latch and the second component is a second overhead bin latch.

In any of the aspects or combinations of the aspects, the groove may be positioned at an end of the inner spindle.

In any of the aspects or combinations of the aspects, the connection rod assembly may further include a flange extending from the outer pin and where the spring is positioned axially between the flange and a disk shaped section of the actuation interface.

In any of the aspects or combinations of the aspects, the groove may be positioned at an end of the inner spindle.

In any of the aspects or combinations of the aspects, the connection rod assembly may further include a second ball lock connector assembly including, an outer pin slidably mated with an inner spindle, including an aperture, and coupled to the connection rod, a ball lock bearing at least partially positioned within the aperture, an actuation interface coupled to the inner spindle, slidable with regard to the outer pin, and including a sleeve at least partially surrounding the outer pin, and a spring positioned within the outer pin, where in a locked configuration the spring is unloaded and the ball lock bearing radially extends beyond an outer surface of the outer pin and engages with a groove in a second latch component, and where in an unlocked configuration the spring is loaded and the ball lock bearing is retained in a groove in the inner spindle.

In any of the aspects or combinations of the aspects, the connection rod may transfer motion from a first component to a second component.

In any of the aspects or combinations of the aspects, the component may be a latch in an aircraft storage bin.

In any of the aspects or combinations of the aspects, actuation of the actuation interface may include moving the actuation interface in an axial direction away from the ball lock bearing.

In any of the aspects or combinations of the aspects, the ball lock connector further may include a flange extending from the outer pin and where the spring is positioned axially between the flange and a disk shaped section of the actuation interface.

In any of the aspects or combinations of the aspects, the outer pin may be coupled to the connection rod via a set screw extending through an opening in the outer pin and mating with a recess in the connection rod.

Those skilled in the art will realize that the process sequences described above may be equivalently performed in any order to achieve a desired result. Also, sub-processes may typically be omitted as desired without taking away from the overall functionality of the processes described above.

The detailed description provided above in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples. Note that the example assembly routines included herein can be used with various connection rod assemblies configurations.

Various actions, operations, and/or functions illustrated and described herein may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used.

It will be appreciated that the configurations and routines disclosed herein are exemplary in nature, and that these specific embodiments are not to be considered in a limiting sense, because numerous variations are possible. For example, the above technology can be applied to a broad range of manufacturing fields such as the aerospace industry, the construction industry, the maritime industry, etc. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A connection rod assembly comprising:
a connection rod;
a first ball lock connector including;
an outer pin slidably mated with an inner spindle, including an aperture, and coupled to the connection rod;
a ball lock bearing at least partially positioned within the aperture;
an actuation interface coupled to the inner spindle, slidable with regard to the outer pin, and including a sleeve at least partially surrounding the outer pin; and
a spring positioned within the outer pin;
where in a locked configuration the spring is unloaded and the ball lock bearing radially extends beyond an outer surface of the outer pin and engages with a detent in a first component; and
where in an unlocked configuration the spring is loaded and the ball lock bearing is retained in a groove in the inner spindle.

2. The connection rod assembly of claim 1, further comprising an aircraft storage bin, where the first component is included in the aircraft storage bin.

3. The connection rod assembly of claim 1, further comprising a flange extending from the outer pin.

4. The connection rod assembly of claim 3, where the spring is positioned axially between the flange and a disk shaped section of the actuation interface.

5. The connection rod assembly of claim 3, where an outer diameter of the flange is equivalent to an outer diameter of the actuation interface.

6. The connection rod assembly of claim 1, where the outer pin is fixedly connected to the connection rod via a set screw extending through an opening in the outer pin and mating with a recess in the connection rod.

7. The connection rod assembly of claim 1, where the connection rod transfers motion from a first component to a second component.

8. The connection rod assembly of claim 1, further comprising:
a second ball lock connector assembly including;
an outer pin slidably mated with an inner spindle and including an aperture;
a connection rod coupled to the outer pin;
a ball lock bearing at least partially positioned within the aperture;
an actuation interface coupled to the inner spindle, slidable with regard to the outer pin, and including a sleeve at least partially surrounding the outer pin; and
a spring positioned within the outer pin;
where in a locked configuration the spring is unloaded and the ball lock bearing radially extends beyond an outer surface of the outer pin and engages with a detent in a second component; and
where in an unlocked configuration the spring is loaded and the ball lock bearing is retained in a groove in the inner spindle.

9. The connection rod assembly of claim 8, where the first component is a first overhead bin latch and the second component is a second overhead bin latch.

10. The connection rod assembly of claim 8, where the groove is positioned at an end of the inner spindle.

11. A connection rod assembly in an aircraft storage bin comprising:
a connection rod;
a first ball lock connector including;
an outer pin slidably mated with an inner spindle, including an aperture, and coupled to the connection rod;
a ball lock bearing at least partially positioned within the aperture;
an actuation interface coupled to the inner spindle and slidable with regard to the outer pin; and
a spring positioned within the outer pin;
where in a locked configuration the spring is unloaded and the ball lock bearing radially extends beyond an outer surface of the outer pin and engages with a detent in a first latch component; and
where in an unlocked configuration the spring is loaded and the ball lock bearing is retained in a groove in the inner spindle.

12. The connection rod assembly of claim 11, further comprising a flange extending from the outer pin and where the spring is positioned axially between the flange and a disk shaped section of the actuation interface.

13. The connection rod assembly of claim 11, where the groove is positioned at an end of the inner spindle.

14. The connection rod assembly of claim 11, further comprising:
a second ball lock connector assembly including;
an outer pin slidably mated with an inner spindle, including an aperture, and coupled to the connection rod;
a ball lock bearing at least partially positioned within the aperture;
an actuation interface coupled to the inner spindle, slidable with regard to the outer pin, and including a sleeve at least partially surrounding the outer pin; and
a spring positioned within the outer pin;
where in a locked configuration the spring is unloaded and the ball lock bearing radially extends beyond an outer surface of the outer pin and engages with a groove in a second latch component; and
where in an unlocked configuration the spring is loaded and the ball lock bearing is retained in a groove in the inner spindle.

15. The connection rod assembly of claim 11, where the connection rod transfers motion from a first component to a second component.

16. A method for assembly of a storage bin in a passenger compartment of an aircraft comprising:
placing a connection rod assembly into the storage bin, the connection rod assembly including;
a connection rod;
a first ball lock connector including;
an outer pin slidably mated with an inner spindle, including an aperture, and coupled to the connection rod;
a ball lock bearing at least partially positioned within the aperture;
an actuation interface coupled to the inner spindle and slidable with regard to the outer pin; and
a spring positioned within the outer pin; and
actuating the actuation interface in the first ball lock connector;
moving the first ball lock connector into an unlocked configuration where the spring is loaded and the ball lock bearing is retained in a groove in the inner spindle;
mating the first ball lock connector with a first latch in the storage bin; and
moving the first ball lock connector into a locked configuration where the spring is unloaded and the ball lock bearing radially extends beyond an outer surface of the outer pin and engages with a detent in the first latch.

17. The method of claim 16, where the connection rod assembly further comprises;
a second ball lock connector including;
an outer pin slidably mated with an inner spindle, including an aperture, and coupled to the connection rod;
a ball lock bearing at least partially positioned within the aperture;
an actuation interface coupled to the inner spindle and slidable with regard to the outer pin; and
a spring positioned within the outer pin.

18. The method of claim 17, further comprising;
actuating the actuation interface in the second ball lock connector;
moving the second ball lock connector into an unlocked configuration where the spring in the second ball lock connector is loaded and the ball lock bearing of the second ball lock connector is retained in a groove in the inner spindle of the second ball lock connector;
mating the second ball lock connector with a second latch in the storage bin; and
moving the second ball lock connector into a locked configuration where the spring is unloaded and the ball lock bearing in the second ball lock connector radially extends beyond an outer surface of the outer pin in the second ball lock connector and engages with a detent in the second latch.

19. The method of claim 16, where actuation of the actuation interface in the first ball lock connector includes moving the actuation interface in an axial direction away from the ball lock bearing.

20. The method of claim 16, where the first ball lock connector further includes a flange extending from the outer pin and where the spring is positioned axially between the flange and a disk shaped section of the actuation interface.
